(19) United States
(12) Patent Application Publication
(10) Pub. No.: US 2019/0249425 A1
(43) Pub. Date: Aug. 15, 2019

(54) MULTIFUNCTIONAL CEILING STRUCTURE

(71) Applicant: Liaver GmbH & Co.KG, llmenau (DE)

(72) Inventors: Ronald TSCHIERSCH, Stuetzerbach (DE); Christian HOPPE, Erfurt (DE); Armin Buehler, Markt Rettenbach (DE)

(21) Appl. No.: 16/345,840

(22) PCT Filed: Oct. 26, 2017
(86) PCT No.: PCT/EP2017/077444

§ 371 Date: Apr. 29, 2019

(30) Foreign Application Priority Data
Oct. 27, 2016 (DE) 102016120554.0

(51) Int. Cl. E04B 9/00; E04B 9/18; E04B 9/04; E04B 9/30; E04B 1/94; F24D 3/14; F24D 3/16; G10K 11/162

(52) U.S. Cl. CPC E04B 9/001; E04B 9/18; E04B 9/0421; E04B 9/30; E04B 2009/186; E04B 1/942; F24D 3/14; F24D 3/165; G10K 11/162; E04B 1/948

(57) ABSTRACT

A multifunctional ceiling structure, in particular for living spaces and workspaces, and includes multiple heat-conducting profiles that are directly or indirectly fastened to a building ceiling, and a downwardly directed mounting surface, with a line receiving region formed in the mounting surface. Furthermore, a heating medium line is provided that runs in the line receiving region of the heat-conducting profiles and conducts a heat-transporting medium. A ceiling panel is fastened to the mounting surface of the heat-conducting profiles and is in heat-conducting contact with the heating medium line. An absorber strip made up of sound absorber elements extends along an upper abutting edge that runs between a building wall and the plane of the ceiling panel. The sound absorber elements have a width of 200-400 mm, a thickness of 25-65 mm, and a length-specific flow resistance in the range of 8-10 kPa*s/m⁴.

### BACKGROUND OF THE INVENTION

The present invention relates to a multifunctional ceiling structure, in particular for living spaces and workspaces.

Various ceiling structures are known from the prior art that are generally specifically adapted to the particular application. As part of optimized and at the same time variable space utilization in the private sphere, but primarily in the public sphere, increasingly more functions are being implemented at the ceilings of rooms, such as heating and cooling, lighting, acoustic design, sound insulation, fire protection, and/or media supply. Such installations are being provided in new buildings, but also in the modernization of existing buildings.

In particular for modernization, so-called suspended ceilings, which in the simplest case are made up of a suspended support structure and ceiling panels mounted thereon, are installed in existing buildings. A visually appealing design is relatively simple to achieve with only minor loss in the room height.

A panel heating and cooling system that is usable for applications as floor, wall, or ceiling heating/cooling is known from DE 10 2010 036 439 A1. The system includes panel heating/cooling modules having a thermally insulating bottom layer and a top layer with good heat conduction, the top layer being connected to the bottom layer with integration of piping that conducts a heat transfer medium.

Wall or ceiling cladding having a cooling and/or heating system, in particular according to the heat radiation principle, is known from EP 2 960 585 A1. The wall or ceiling cladding is fastenable to the wall or ceiling of a building via at least one mounting profile. The mounting profile has a first holding means for a pipe on a side facing the room to be cooled or heated. A receiving opening of the holding means faces the room. A straight section of the pipe is fixedly connected to the holding means in the mounting profile to form an integral component.

DE 20 2005 000 336 U1 discloses an acoustic ceiling designed as an arrangement of at least two butt-jointed perforated gypsum boards. A butt joint formed by the board edges extends between sharp edges of the perforated gypsum boards and is covered by joint tape. The joint tape is made of a fiber fleece, the fiber being a chemical and/or synthetic fiber. The joint tape is adhesively bonded to the surface of the boards in the area of the butt joint.

Sound-absorbing elements for improving the room acoustics, i.e., for better speech intelligibility and for hearing protection, have been known for quite some time. Acoustic ceilings made of gypsum board or fiberboard improve the room acoustics, reduce the reverberation, and convert sound energy into heat. For absorption of high sonic frequencies, it is common to use perforated panels that are mounted at certain distances from the wall or also on the ceiling. Sound-deadening and sound-insulating materials such as foams or felts are situated between panels and the underlying building surfaces.

Sound absorber elements made of sintered expanded glass granulate are commercially available, for example from Liaver GmbH & Co. KG under the trade name Reapor.

Most of the previously known, efficiently acting sound absorption solutions must either be installed at the outset in the rooms to be acoustically improved or retrofitted with significant effort. This frequently involves a tradeoff between the acoustic effects and the other design aspects of the room from functional, construction, and design standpoints. For example, good acoustic effects may be achieved by covering the entire surface of the ceiling with sound absorber panels but providing ceiling air conditioning elements is then no longer possible. Retrofitting acoustically insulating ceilings in existing rooms is complicated in terms of construction and is costly, so that it is seldom undertaken.

DE 10 2016 108 945.1, unpublished as of the filing date of the present application, describes a sound absorber arrangement made up of multiple sound absorber elements that are mounted in a room having walls and a ceiling that closes the room at the top. Multiple sound absorber elements lined up in a row form one or more absorber strips that extend, at least in sections, along an upper abutting edge running between the wall and the ceiling of the room.

DE 1 912 020 A describes a building element for radiation heating, cooling, and/or conditioning units. The building element includes an insulating layer having recesses on its bottom side for accommodating pipes. An influencing medium may be conducted through the pipes. The pipes are enclosed by heat distribution elements, preferably heat-conducting lamellae. The heat-conducting lamellae encompass the insulating layer with their flat, bent ends, and lie closely against a radiation layer. The bottom surface of the radiation layer faces the room to be influenced and is fixedly connected to the heat-conductive elements and the insulating layer. The radiation layer may be provided with holes for purposes of sound insulation.

In the technical article “PhoneSTOP-Schallabsorption innen and außen—auch zum Nachrusten” [PhoneSTOP interior and exterior sound absorption—also for retrofits”], Mar. 17, 2006 (http://www.baulinks.de/webplugin/2006/0466.php4), an acoustic panel made of expanded glass granulate is described, which for sound insulation may be subsequently glued to wall and ceiling surfaces.

US 2014/0071662 A1 discloses the combination of lighting devices with elements for improving the room acoustics. The described approaches are used in conference rooms, for example.

The above-mentioned approaches as well as numerous others generally allow achievement of one specific function in addition to the visual appearance of the ceiling. However, none of the previously known approaches allows the simultaneous achievement of a number of functions in the ceiling of a room, in any case while maintaining a low installation height, although there has been a need for such for some time. In particular when more stringent fire protection requirements are imposed on the fire resistance of the ceiling structure, functions such as air conditioning and acoustic improvement may be implemented only with a high level of effort and a tall, multi-layer structure. Under such requirements, in practice multiple self-contained ceiling levels are constructed, which is possible only for large ceiling heights and high load-bearing building ceilings.

The object of the present invention, therefore, is to provide a multifunctional ceiling structure that allows a visually appealing design, the implementation of heating and/or cooling functions, and at the same time, a marked improvement in the room acoustics over a wide frequency range. The aim is to achieve improved absorption results in particular in rooms having a floor area >40 m². The overall ceiling structure should occupy minimal volume in the room and be practically unnoticeable. The ceiling structure should preferably also meet current fire protection requirements for public buildings.

### SUMMARY OF THE INVENTION

The object is achieved by a multifunctional ceiling structure according to appended claim 1.

The multifunctional ceiling structure according to the invention is particularly suited for use in living spaces and workspaces, but primarily for public buildings having stricter requirements for room acoustics, energy efficiency, and fire protection. In particular, the ceiling structure is also suited for the modernization/renovation of older buildings, since it has a low weight per unit area and a small installation height.

The ceiling structure includes multiple heat-conducting profiles that are mounted on a building ceiling, for example directly screwed on, by means of hangers and/or support profiles or affixed in some other suitable manner. The heat-conducting profiles have a downwardly directed mounting surface, wherein a line receiving region is formed in the mounting surface. A heating medium line, which may be made up of multiple line sections, runs in the line receiving region of the heat-conducting profiles and conducts a heat-transporting medium, which for heating and cooling purposes is connected to an appropriate facility.

The ceiling structure also includes at least one ceiling panel that is fastened to the mounting surface of the heat-conducting profiles and is in heat-conducting contact with the heating medium line. The ceiling panel is generally made up of numerous panel elements that may have a decorative design on their bottom side directed toward the room in order to form the visible surface of the ceiling structure.

Lastly, the ceiling structure has at least one absorber strip that is made up of multiple sound absorber elements and extends, at least in sections, along an upper abutting edge that runs between a building wall and the plane of the ceiling panel. The sound absorber elements have a width of 200-400 mm, a thickness of 40-65 mm, and a length-specific flow resistance in the range of 8-10 kPa*s/m⁴. These dimensions of the absorber strip, under the condition of mounting it adjacent to the upper abutting edge between the wall and the ceiling, result in surprisingly pronounced sound absorption effects with a comparatively small absorber surface.

One advantage of the multifunctional ceiling structure is seen in that the air conditioning function as well as the improvement in the room acoustics are integrated into a ceiling structure having a low installation height. The ceiling structure according to the invention is particularly efficient with regard to the sound-absorbing effect in rooms having a floor area >4 m² and <150 m².

According to one preferred embodiment, the ceiling panel is designed with a closed bottom side that is directed toward the room. The perforated panels having an open bottom side, which are typically necessary in acoustic applications, are not needed here since the acoustic properties are achieved to the desired extent by the absorber strip.

In one particularly preferred embodiment, the ceiling panel is made of a noncombustible, fire-retardant material. The ceiling panel is in particular designed as a fire protection panel that meets the requirements for certain fire resistance classes. Fire protection panels of fire resistance class F30, F60, or F90 are preferably used. In addition, the absorber strip is also preferably made of a fire-retardant material, so that it not only improves the acoustics, but also fulfills fire protection functions. The ceiling structure, without other adaptations, thus allows compliance with stringent fire protection values. This is possible due to the fact that the entire ceiling surface may have a closed design in order to meet strict fire protection requirements.

In one advantageous embodiment, an outer side of the heating medium line runs in a plane with the mounting surface of the support profiles in order to achieve good heat transfer between the heating medium line and the ceiling panel. In modified embodiments, this is achieved by additional elements such as heat-conducting plates or the like.

In one modified embodiment, a metallic heat-conducting plate or a metallic foil may run between the top side of the ceiling panel and the mounting surfaces of the heat-conducting profiles. The heat-conducting plate improves the heat transfer from the heating medium line to the ceiling panel, and thus increases the efficiency in heating/cooling the room.

One advantageous embodiment of the multifunctional ceiling structure is characterized in that the ceiling panel extends essentially to the building wall. In this case the absorber strip is mounted on the bottom side of the ceiling panel directed toward the room. For ensuring compliance with fire protection requirements, in this embodiment properties of the sound absorber elements are not important, since the fire-retardant ceiling panel has a continuous design.

In one modified embodiment, a strip-shaped free space in which the absorber strip runs extends between the ceiling panel and the building wall. The bottom side of the ceiling panel directed toward the room and the bottom side of the absorber strip directed toward the room are preferably situated in a plane. In this case, for achieving a high level of fire protection properties it is necessary for the sound absorber elements to likewise be made of fire-retardant material, in particular expanded glass, as described in greater detail below.

In yet another modified embodiment, the ceiling panel has a two- or multi-layer design, the topmost layer preferably extending essentially to the building wall, and the downwardly directed layer leaving open the strip-shaped free space in which the absorber strip runs. It is also possible for a layer of the ceiling panel to be made of clay, gypsum, or a similar material in order to produce an automatically acting fire protection plane and still maintain a high output density in cooling operation.

One refined embodiment of the multifunctional ceiling structure has hangers with a vibration damping section. As a result, the ceiling structure has particularly good sound-insulating properties due to the fact that the impact sound from a building story situated above the ceiling structure is decoupled by the ceiling panels.

One embodiment of the ceiling structure that is refined in another aspect is characterized in that a metallic heat-conducting plate is situated, at least in sections, between the ceiling panel and the mounting surface of the heat-conducting profiles. The efficiency of the heating and cooling function may be increased in this way.

One preferred embodiment uses an elastic fire protection seal between the edge of the ceiling panel and/or the edge of the absorber strip. Stringent fire protection requirements may thus be met, since appropriate precautions are also taken in the necessary joint area to prevent the premature spread of heat and flames.

The ceiling panel particularly preferably meets a fire resistance stipulated, for example, by standards or comparable regulations. This may be achieved using panels made of gypsum, clay, and cement, or composites (expanded glass/gypsum, cement/expanded glass, clay/expanded glass, for example).

It is particularly advantageous for the absorber strip to be detachably mounted in the ceiling structure. The absorber strip may then be removed for maintenance, for example, and subsequently reused. In particular a magnetic connection is suitable for fastening the absorber strip, wherein magnets that cooperate with the metallic surfaces of the support profiles are recessed into the absorber strip.

According to one modified embodiment, room lighting means may be additionally integrated into the ceiling panel or into the free space in which the absorber strip is mounted.

Yet another modified embodiment is characterized in that an absorber strip made of fire-retardant material is mounted essentially vertically on the building wall, in this case as well the absorber strip extending to the abutting edge between the building wall and the plane in which the ceiling panel is situated. The absorber strip thus abuts the ceiling panel from below. In addition to the described acoustic advantages, this also provides benefits with regard to fire protection requirements, since a construction-related joint between the wall and the ceiling is closed by the absorber strip, so that the spread of fire in this critical region is avoided.

One preferred embodiment uses a ceiling panel made of a moisture-absorbent material made in particular of a material mixture of wood, clay, gypsum, and/or gypsum fiber. The moisture-absorbent ceiling panel itself preferably forms a vapor-tight plane. This may be achieved by an additional vapor barrier or a vapor barrier that is already applied to the ceiling panel. In the application for room cooling, this design provides the option for setting the temperature of the heat-transporting medium (typically water) in the heating medium line to below the dew point temperature of the room air, without moisture precipitating at the heating medium line, the heat-conducting profiles, or in the cavity above the ceiling panel. Instead, moisture precipitates at the bottom side of the ceiling panel on the side facing the room. The ceiling panel takes in the precipitated moisture in an interplay of adsorption and absorption. This has several positive effects: The room air moisture is reduced. This reduces the tendency for mold formation, and at the same time increases the comfort for persons in the room due to improvement in the perception of coldness. The heat conductivity of the ceiling panel increases markedly, so that the cooling power also increases. The fire protection properties are improved due to the increase in the water content of the ceiling panel. The sound insulation is improved on account of the increase in weight of the ceiling panel due to the increased water content. This results in additional adiabatic cooling because of the evaporation of the precipitated moisture.

The multifunctional ceiling structure, due to its novel properties, also allows changes in the operating modes during heating or cooling. Thus, targeted operation below the dew point is possible for drying of the room air and increasing the heat conductivity of the ceiling panel, and thus correspondingly increasing the active and/or adiabatic cooling power. This operating mode may likewise increase the operational reliability, in particular during rapid weather changes. At the same time, the control of the cooling system is simplified since the dew point sensor, which is otherwise customary, may be dispensed with.

In the multifunctional ceiling structure, multiple sound absorber elements lined up in a row preferably form one or more absorber strips that extend along one or all upper abutting edges running between the wall and the ceiling of the room. The absorber strip has a width of 200-400 mm, preferably 250-350 mm, particularly preferably 310 mm. The thickness of the absorber strip is 40-65 mm, preferably 50 mm. It is particularly important for the acoustic functionality of the ceiling structure that the sound absorber elements have a length-specific flow resistance in the range of 8-10 kPa*s/m⁴, preferably 8-9 kPa*s/m⁴. It has surprisingly been shown that flow resistances outside the stated range do not result in the desired absorption, even when the flow resistances in the sound absorber elements vary greatly, and in any case thus sometimes lie outside the range identified by the invention.

The length-specific flow resistance of the sound absorber elements used preferably varies by less than 0.5 kPa*s/m⁴, preferably less than 0.3 kPa*s/m⁴, relative to the surface area of such an element. This small variation in the length-specific flow resistance is particularly preferably valid over the entire absorber strip, in each case considering the length-specific flow resistance on a surface area of the absorber strip <0.5 m², preferably <0.3 m², particularly preferably <0.1 m².

The room equipped with a ceiling structure according to the invention is used for residential, work, or other habitation-related purposes. The room has at least one absorber strip situated at an upper edge of the room. For the acoustic effect, it is essential that the sound absorber elements are designed as absorber strips and extend, at least in sections, along the upper edge of the room.

One important advantage of the room equipped in this way is that a particularly high level of sound absorption may be achieved by arranging the absorber strip at the upper edge (abutting edge) of the room. This high absorption effect is achieved by the reflections of the sound waves that occur in this area, on the wall, and on the ceiling. The sound absorber element designed as an absorber strip may be integrated into the ceiling structure with little effort and requires only a small amount of installation space. As the result of arranging the absorber strip at the upper edge of the room, there is only minimal limitation of the surface area and volume available in the room for other uses.

By using sound absorber elements having a length-specific flow resistance in the range of 8-10 kPa*s/m⁴, preferably 8-9 kPa*s/m⁴, it is possible to achieve very efficient sound absorption in a wide frequency range with small volumes of the sound-absorbing material and of the space occupied by the absorber strip. In particular, relatively thin sound absorber elements may be mounted directly in the edge region of the acoustically highly reflective ceiling without leaving an appreciable air space in between. The ceiling panel situated behind the absorber strip (according to the above-mentioned embodiment) diffusely reflects the sound waves, which have already passed once through the absorber strip, back into the absorber strip, where further absorption can then take place. For this particularly efficient absorption, the length-specific flow resistance must be set in the stated range, for example by a suitable selection of the grain size and the material composition of the sound absorber elements used. The sound absorber elements are particularly preferably made of expanded glass granulate having a grain size of 0.25-4 mm, the granulate being sintered in panel form or joined with added binder.

The acoustic effects utilized in the invention are thus based on a combination of the stated characteristics of the sound absorber elements and their stated arrangement in the ceiling structure.

According to one particularly preferred embodiment, the absorber strip extends circumferentially at the upper edges of the room, in each case as an integral part of the ceiling structure. Very good sound absorption is achieved by using a circumferential absorber strip. If a circumferential course of the absorber strip is not possible for structural reasons, for example, the absorber strip may also be interrupted in areas, wherein good sound absorption may be achieved in this case as well.

One advantageous embodiment uses multiple absorber strips. Each absorber strip once again extends, at least in sections, at an upper edge of the room, in each case as an integral part of the ceiling structure. The absorber strips may be designed, for example, in the form of easily handled narrow panels that preferably continuously adjoin one another. However, spaces may be present between individual absorber strips if necessary.

The absorber strip is preferably fastened to the ceiling panel or runs next to same in the free space between the ceiling panel and the building wall. The absorber strip extends in each case to the upper abutting edge of the room, i.e., up to the corner formed between the wall and the ceiling. A joint filled with elastic sealing material may be provided in the abutting edge if necessary. The fastening may take place, for example, using a suitable adhesive on the ceiling panel. Alternatively, the absorber strip may be fixed to the ceiling panel or to the support profiles using clamps or other suitable mechanical fastening means. It is also conceivable to use a specialized support profile in which the absorber strip is clamped or fastened in some other way. Detachable fastening is particularly suitable, with the absorber strip covering an underlying inspection opening in the ceiling structure.

According to one advantageous embodiment, the absorber strip is made of an acoustically active, sound-absorbing nonductile foam. This is preferably a mineral material that forms a rigid foam. Glass-based acoustically active and breathable foam, which preferably contains expanded glass granulate, has proven to be a particularly suitable material for the sound absorber elements that form the absorber strip. For this purpose, individual glass particles are joined together by sintering or by use of a binder, which may have a fiber component. The material used for the absorber strip is advantageously suitable for wet rooms and is frost-resistant, flame-retardant, and very lightweight, so that it is usable in many different types of rooms. It may also be easily cut to size.

The length-specific flow resistance of the sound absorber element required according to the invention may be set particularly easily by the grain sizes used, i.e., the grain size distribution in the preferably plate-shaped sound absorber element and/or the proportion of binder that is added to the expanded glass granulate during manufacture.

The absorber strip preferably has a width of 250 mm to 500 mm. In addition, a thickness of 25 mm to 60 mm has proven advantageous. An absorber strip with this design may be well integrated into the ceiling structure and requires comparatively little installation space.

Particularly good, inconspicuous integration of the absorber strip may be achieved by recessing it into the ceiling. For this purpose, a corresponding recess is preferably introduced into the ceiling panel or a free space is left open between the ceiling panel and the building wall. The absorber strip preferably ends in flush alignment with the bottom side of the ceiling panel. This installation variant is particularly suited for new buildings when the recesses may be taken into account during the planning phase, or for pending major renovations. The free spaces or recesses may be provided in the drywall constructions of the ceiling structure, and then fitted with sound absorber elements.

A floor area between 80 m² and 130 m² with a wall height of 2 to 3 m has proven advantageous for the room that is sound-insulated in this way. Particularly good sound absorption results may be achieved in this range with the sound-absorbing absorber strip used.

In order to achieve the best acoustic absorption effects for rooms having a floor area much greater than 120 m², it is necessary to acoustically divide the room into multiple cells. This may be achieved by mounting further sound absorber elements, which preferably have the same properties as the sound absorber elements used in the ceiling structure described above. The further sound absorber elements are fastened to the ceiling panel or recessed into it, thus dividing the room into the stated cells.

Reverberation times in the range of 0.6 s to 0.9 s are achievable in rooms furnished with the sound absorber arrangement integrated into the ceiling structure according to the invention, which corresponds to the target value in communication spaces. In unfurnished rooms with reinforced concrete walls, the reverberation time is reduced from 2-4 s to 0.8-1.2 s due to use of the sound absorber elements. The sound absorber arrangement is suitable in particular for damping in the frequency range of 250 Hz to 4 kHz.

In one modified embodiment, absorber strips are mounted on the wall and also on the ceiling structure, and in each case extend to the upper abutting edge of the room, i.e., abut one another in the corner area between the wall and the ceiling. Alternatively, corner profiles made of absorber strips may be used, which are mounted directly in the corner area of the room.

One embodiment is advantageous in which the surface of the absorber strip directed toward the room has a textured surface. The texturing may further improve the absorption properties and at the same time may provide an esthetic design, so that the absorber strip has the appearance of a border or a cornice.

### BRIEF DESCRIPTION OF THE DRAWINGS

Further particulars and advantages of the ceiling structure according to the invention and the sound-insulated room equipped with same result from the following description of preferred embodiments, with reference to the drawings, which show the following:

FIG. 1 shows a simplified sectional view of a first embodiment of a multifunctional ceiling structure according to the invention, with an absorber strip mounted on a ceiling panel;

FIG. 2 shows a simplified sectional view of a second embodiment of the multifunctional ceiling structure, with an absorber strip integrated into a ceiling panel;

FIG. 3 shows a bottom view of the ceiling, not true to scale, of a sound-insulated room equipped with the multifunctional ceiling structure;

FIG. 4 shows the absorber strip in the room, situated on the ceiling panel;

FIG. 5 shows a simplified sectional view of a modified embodiment of the multifunctional ceiling structure, with absorber strips integrated into the ceiling panel but with omission of support profiles;

FIG. 6 shows a simplified sectional view of another modified embodiment of the multifunctional ceiling structure, with absorber strips mounted on the ceiling panel but with omission of support profiles;

FIG. 7 shows a simplified sectional view of further embodiments of the multifunctional ceiling structure;

FIG. 8 shows a simplified sectional view of a modified embodiment of the multifunctional ceiling structure, with absorber strips mounted on the building wall;

FIG. 9 shows a simplified sectional view of a modified embodiment of the multifunctional ceiling structure, with absorber strips integrated into the building wall; and

FIG. 10 shows a diagram illustrating measured values of the reverberation time in differently configured rooms over a wide frequency range.

### DETAILED DESCRIPTION OF THE INVENTION

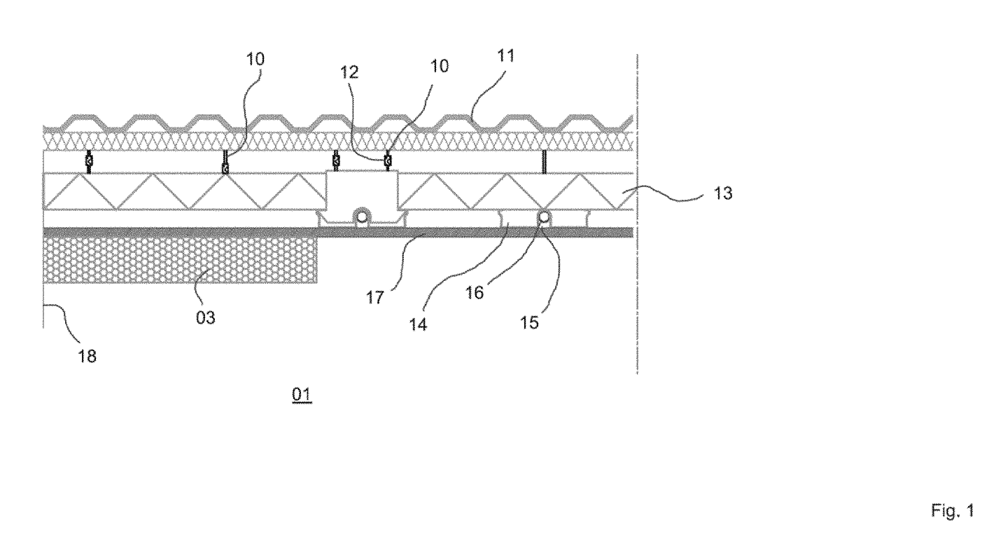

FIG. 1 shows a simplified sectional view of a first embodiment of a multifunctional ceiling structure according to the invention. The ceiling structure here includes numerous hangers 10 that are mounted on a building ceiling 11 and that extend downwardly into a room 01. The hangers 10 preferably have a vibration damping section 12 via which acoustic decoupling and damping, in particular of impact sound from building stories situated above the building ceiling 11, take place. The ceiling structure in this case has further support profiles 13 that are mounted on the hangers 10. Multiple heat-conducting profiles 14 having a downwardly pointing mounting surface are mounted on the support profiles 13. Provided in the mounting surface of the heat-conducting profiles 14 is a line receiving region 15 that extends along the longitudinal axis of the support profile. Sections of a heating medium line 16 are laid in the receiving region 15, preferably with optimized heat-conductive contact with the climate profile, so that good heat transport to and from the mounting surfaces may take place.

A ceiling panel 17 whose bottom side is directed toward the room 01 is mounted on the mounting surfaces of the heat-conducting profiles 14. The ceiling panel 17 is in good direct or indirect heat-conductive contact with the heating medium line 16, so that heating or cooling of the room 01 takes place, depending on the temperature of the heating medium flowing through the heating medium line 16.

Lastly, the ceiling structure has an absorber strip 03, which in the embodiment illustrated in FIG. 1 is mounted on the bottom side of the ceiling panel 17, in particular in such a way that the absorber strip 03 extends to the abutting edge between the ceiling panel 17 and an adjoining building wall 18. In addition, a flexible fire protection seal (not shown) may be mounted in the appropriate joint in order to seal between the ceiling panel 17 and the adjoining building wall 18.

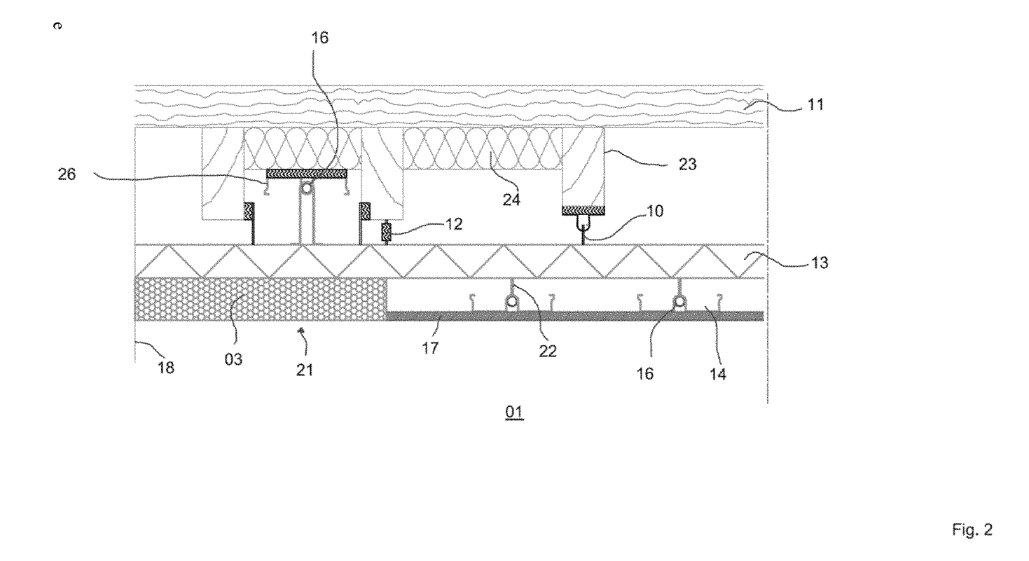

FIG. 2 shows a simplified sectional view of a second embodiment of the multifunctional ceiling structure. The main difference from the embodiment described above is that the absorber strip 03 is not attached to the bottom side of the ceiling panel 17, but instead runs in a strip-shaped free space 21 left open between the ceiling panel 17 and the building wall 18. In this case the absorber strip 03 is fastened to the support profile 13, for example. The width of the absorber strip 03 is preferably dimensioned such that it completely fills the free space between the ceiling panel 17 and the building wall 18; once again a fire protection seal (not shown) may be situated in the joint. The thickness of the absorber strip 03 is preferably dimensioned such that on its bottom side it lies in a plane with the bottom side of the ceiling panel 17, resulting in a uniform appearance of the ceiling surface.

Another special feature of the embodiment shown in FIG. 2 is the connection between the support profile 13 and the heat-conducting profiles 14, implemented here by intermediate hangers 22. The hangers 10 may be mounted on the ceiling beam 23, for example, depending on the design of the building ceiling. Lastly, FIG. 2 illustrates that thermal insulation 24 may be situated in a cavity between the support profile and the building ceiling 11 to limit heat loss at the top. In particular applications, upper heat-conducting profiles 26, in which further heating medium lines 16 may be laid as needed, may also be situated in this cavity.

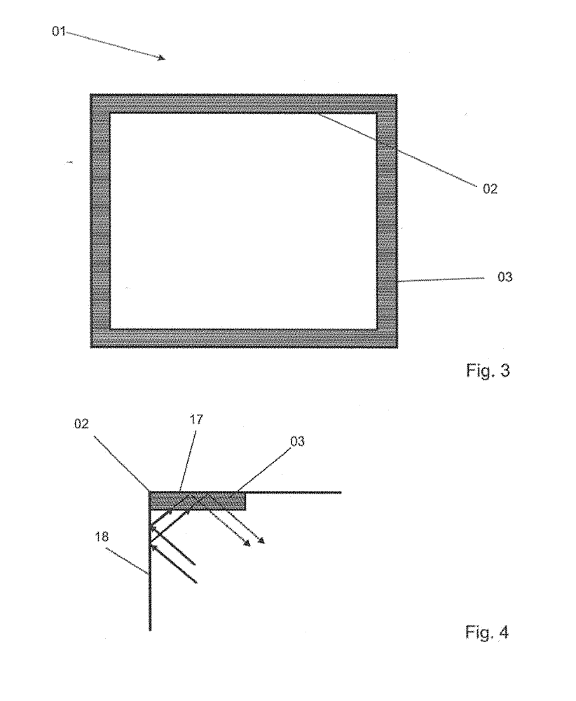

FIG. 3 shows a bottom view of the ceiling, not true to scale, of the room 01 equipped with the ceiling structure according to FIG. 1 or 2. The floor area of the room is preferably 40-130 m². The sound-absorbing absorber strip 03 that extends circumferentially along the abutting edges 02 of the room 01 is situated at the upper abutting edges 02. The absorber strip 03 is situated on the ceiling panel 17 and extends in each case to the corner (abutting edge) formed between the building wall 18 and the ceiling panel 17. There is a fixed, optionally full-surface connection, for example in the form of an adhesive connection or a mechanical connection, for example by means of clamps, between the ceiling panel 17 and the absorber strip 03 or between the ceiling panel 17 and the support profile. Alternatively, the ceiling panel 17 may have the free space 21 for accommodating the absorber strip 03 in a complete or partial cross section.

The absorber strip 03 is made up of one, or preferably multiple, sound absorber elements made of a nonductile foam, preferably a glass-based foam containing a portion of expanded glass granulate. This material is well suited for sound insulation and may be easily processed. The sound absorber elements have a length-specific flow resistance in the range of 8-10 kPa*s/m⁴, preferably 8-9 kPa*s/m⁴.

The absorber strip preferably has a width between 250 mm and 500 mm and a thickness of 25 mm to 60 mm. The absorber strip 03 preferably has a plate-shaped design. Multiple sound absorber elements are continuously lined up in a row, without spaces in between, to form a circumferential absorber strip 03. In alternative embodiments, the absorber strips 03 may also extend only in sections at the upper abutting edges of the room 01.

FIG. 4 shows the absorber strip 03 situated at the upper edge 02 of the room 01, corresponding to the embodiment illustrated in FIG. 1. The reflections of diffuse sound waves occurring in this edge region are illustrated in a highly simplified manner by arrows. The incident sound waves are reflected primarily in the region of the upper edge of the room at the wall and the ceiling, so that a particularly good absorption effect may be achieved by means of absorber strips 03.

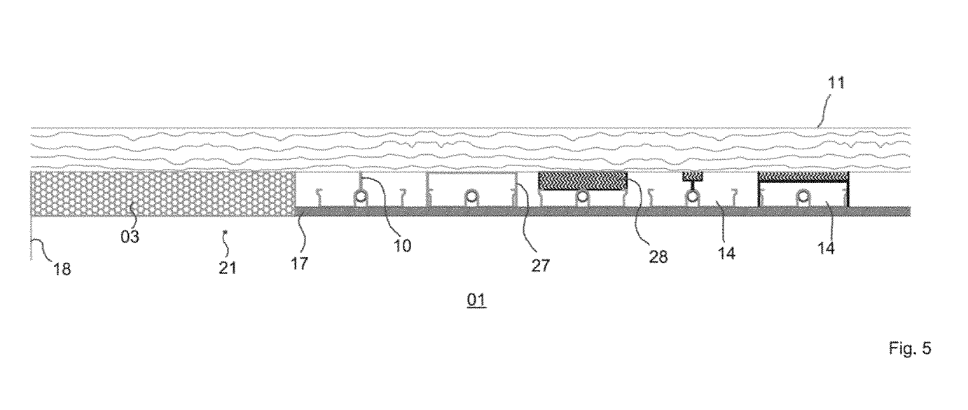

FIG. 5 shows one modified embodiment of the ceiling structure, characterized in particular in that the support profiles have been omitted. In other respects, this embodiment is the same as that shown in FIG. 2, since the absorber strip 03 is situated in a free space 21 between the building wall 18 and the ceiling panel 17. When the support profiles are omitted, the heat-conducting profiles 14 may be mounted on the building ceiling 11 in various ways, a few examples of which are shown in FIG. 5. Thus, the heat-conducting profiles 14 may be directly fastened to the building ceiling 11 via hangers 10, or by insertion into U profiles 27, or by some other way of fastening to the building ceiling 11, preferably with an insulation strip 28 situated in between to prevent undesirable heat transfer into the building ceiling.

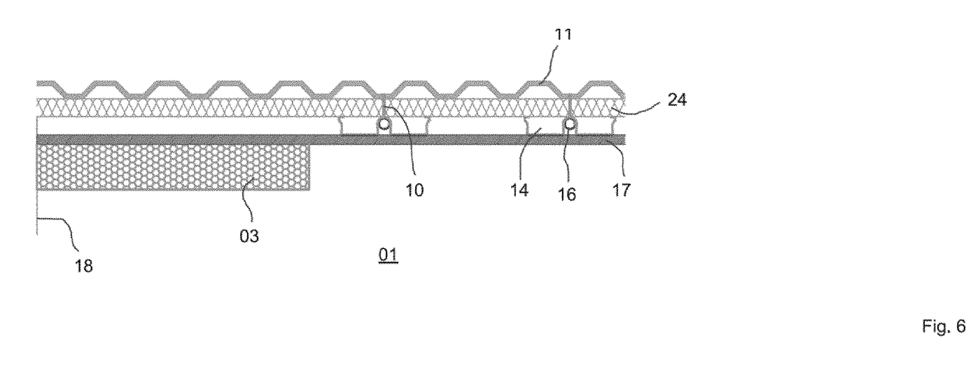

FIG. 6 shows another embodiment of the ceiling structure, likewise, characterized in particular in that the support profiles have been omitted. In other respects, this embodiment is the same as that shown in FIG. 1, since the absorber strip 03 is mounted on the bottom side of the ceiling panel 17. The heat-conducting profiles 14 are directly fastened to the building ceiling 11 via hangers 10. Continuous thermal insulation 24 is situated in the area between the suspended heat-conducting profiles 14 and the bottom side of the building ceiling 11 for insulation purposes.

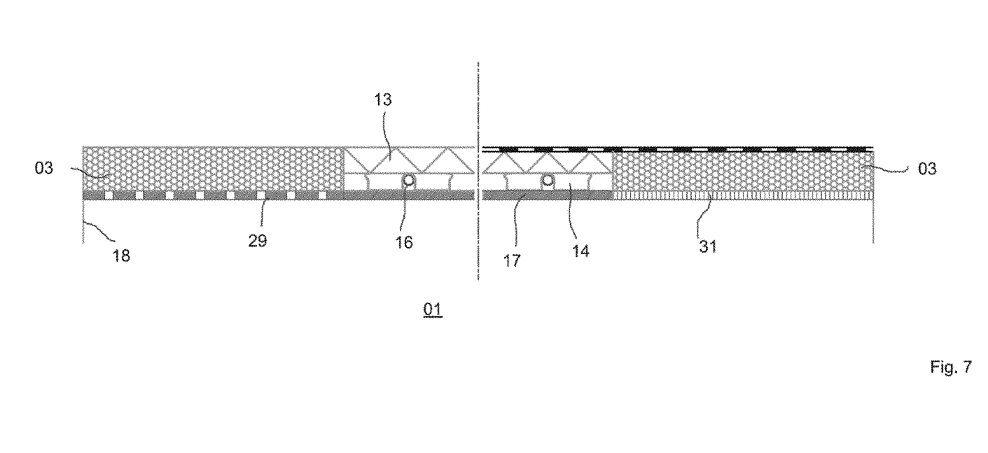

FIG. 7 likewise shows a sectional illustration of further design options for the multifunctional ceiling structure. The building ceiling is not illustrated here. One of the support profiles 13 and two heat-conducting profiles 14 mounted thereon are shown; the manner in which the heat-conducting profiles are mounted on the building ceiling is not relevant. The design of the bottom surface of the ceiling structure differs from the embodiments described above. While the main portion of the surface of the room 01 is spanned by the ceiling panel 17, either a perforated panel 29 or an acoustic panel 31, whose bottom side lies in a plane with the bottom side of the ceiling panel 17, is situated below the absorber strips, i.e., at the edges of the room. This gives the appearance of a flat, two-dimensional room ceiling. However, sufficient acoustic openings, such as holes or pores, are provided in the edge regions to allow the sound waves occurring in the room to have essentially unhindered access to the absorber strips 03.

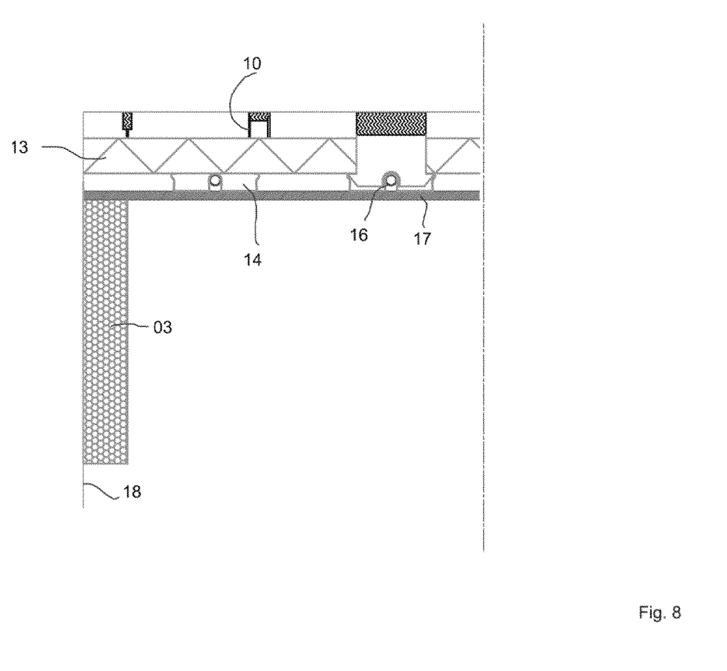

FIG. 8 shows yet another modified embodiment of the ceiling structure, characterized in that the absorber strip 03 is mounted on the building wall 18. In other respects, this embodiment is the same as that shown in FIG. 1. In this case, however, the absorber strip 03 adjoins the bottom side of the ceiling panel 17 and runs vertically on the building wall. The ceiling panel 17 extends above the absorber strip 03 until reaching the building wall, optionally leaving space for an expansion joint. The expansion joint is concealed by the absorber strip 03, which with regard to fire protection requirements results in an increased fire resistance time. The heat-conducting profiles 14 are mounted on the support profile 13, which is fastened to the building ceiling 11 via hangers 10.

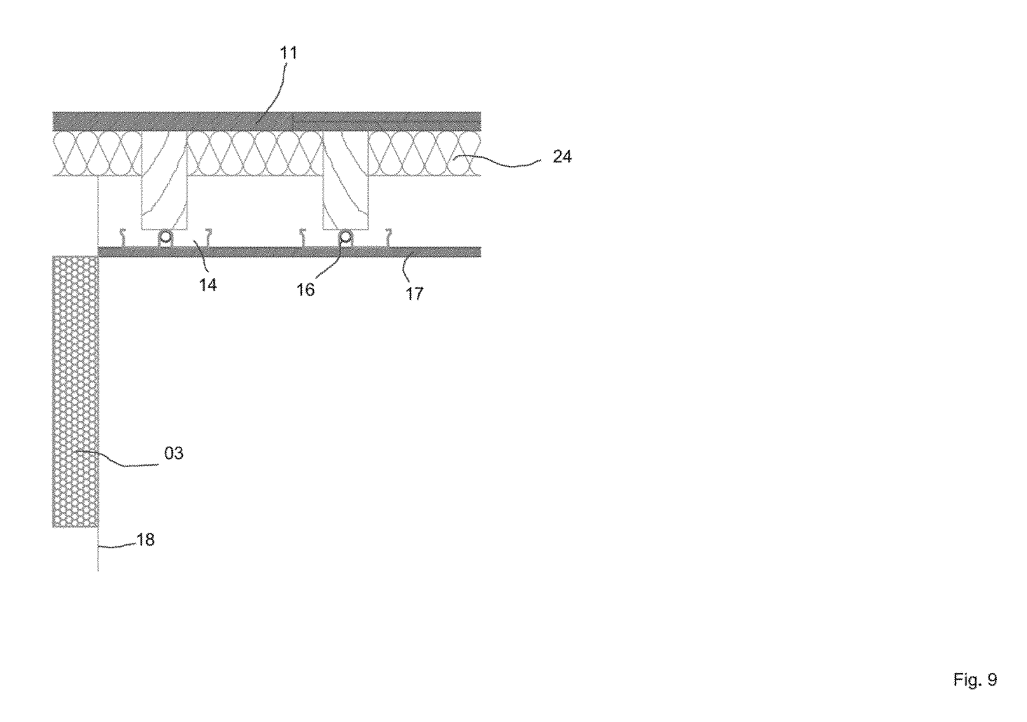

FIG. 9 shows another embodiment of the ceiling structure, likewise, characterized in that the absorber strip 03 is situated at the building wall 18, but is integrated into same instead of being mounted on it, resulting in a continuous wall surface without elevations. In other respects, this embodiment is the same as that shown in FIG. 5. In this case, however, the absorber strip 03 adjoins the bottom side of the ceiling panel 17 and runs vertically on the building wall. The ceiling panel 17 extends to the building wall, optionally leaving space for an expansion joint. The heat-conducting profiles 14 are fastened directly to the building ceiling 11. Continuous thermal insulation 24 is situated in the area between the heat-conducting profiles 14 and the bottom side of the building ceiling 11 for insulation purposes.

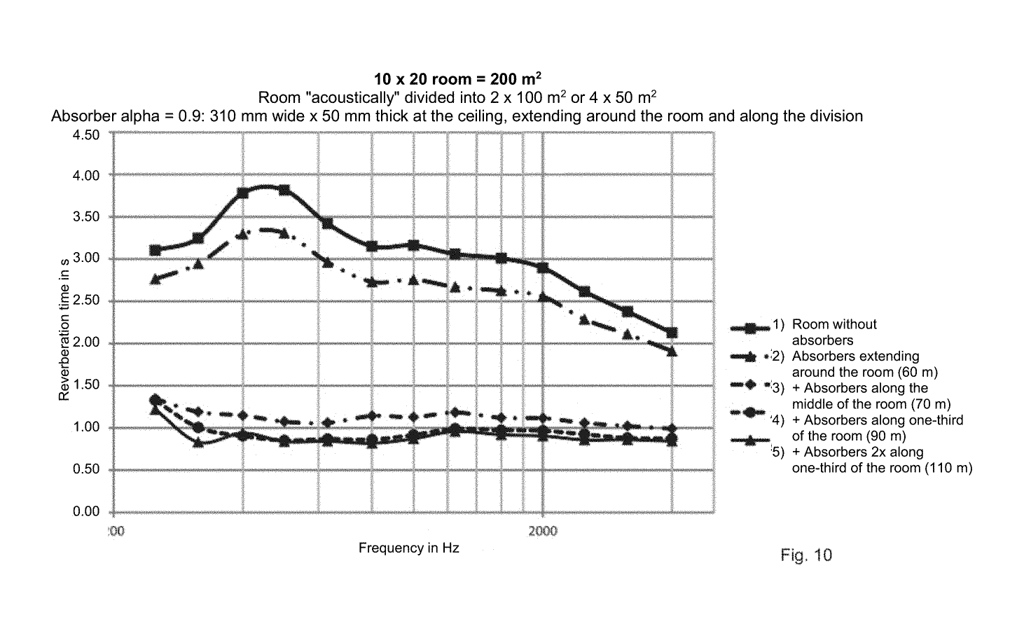

FIG. 10 shows a diagram of multiple measured value curves for the reverberation time over a wide frequency range. The individual curves have been recorded in the same room having a floor area of 10 m×20 m, with the walls and the ceiling made of standard reinforced concrete.

Curve 1) shows the progression of the reverberation time in the original room, i.e., without installation of the sound absorber arrangement.

Curve 2) shows the reverberation time after installation of the absorber strips, mounted circumferentially in the room at the ceiling and in each case running up to the upper abutting edge. The reverberation time decreases uniformly by approximately 0.3-0.4 s over all frequencies. This result is not entirely satisfactory and is attributed to the fact that the room has a floor area much greater than 120 m².

Curves 3), 4), and 5) show the reverberation times in the room when it has been divided into acoustic cells of <120 m². This division was carried out in each case by mounting the same sound absorber elements to the ceiling in the interior of the room along straight lines, resulting in a grid having surface areas of 1×200, 2×100, and 4×50 m². It is apparent that the reverberation times have decreased drastically, by more than 1 s over the entire frequency range. The surprising effect occurs with acoustic room sizes at or below 100 m². The acoustic absorption capacity may also be improved compared to the described sound absorber arrangement, but only by a disproportionately small extent, by multiple installations. The absorber design thus shows an optimum with regard to the quantity of installed absorbers and the achieved absorption capacity.

1. A multifunctional ceiling structure, in particular for living spaces and workspaces, including:
multiple heat-conducting profiles that are directly or indirectly fastened to a building ceiling, the heat-conducting profiles having a downwardly directed mounting surface, wherein a line receiving region is formed in the mounting surface;
a heating medium line in the line receiving region of each of the heat-conducting profiles and conducts a heat-transporting medium;
a ceiling panel fastened to the mounting surface of the heat-conducting profiles and is in heat-conducting contact with the heating medium line; and
an absorber strip, made up of sound absorber elements, the absorber strip extending, at least in sections, along an upper abutting edge that runs between a building wall and a plane of the ceiling panel, wherein the sound absorber elements have a width of 200-400 mm, a thickness of 25-65 mm, and a length-specific flow resistance in the range of 8-10 kPa*s/m4.

2. The multifunctional ceiling structure according to claim 1, wherein the ceiling panel is made of a noncombustible material, and in particular is designed as a fire protection panel.

3. The multifunctional ceiling structure according to claim 1, wherein the ceiling panel extends essentially to the building wall, and the absorber strip is mounted on the bottom side of the ceiling panel that is directed into the room.

4. The multifunctional ceiling structure according to claim 1, wherein a strip-shaped free space in which the absorber strip runs extends between the ceiling panel and the building wall wherein a bottom side of the ceiling panel directed into the room and a bottom side of the absorber strip directed into the room are situated in a plane.

5. The multifunctional ceiling structure according claim 1, wherein the heat-conducting profiles are mounted on support profiles that are mounted on the building ceiling via hangers, wherein the hangers have a vibration damping section.

6. The multifunctional ceiling structure according to claim 1, further comprising a metallic heat-conducting plate or foil situated, at least in sections, between the ceiling panel and the mounting surface of the heat-conducting profiles.

7. The multifunctional ceiling structure according to claim 1, further comprising an elastic fire protection seal that runs between the edge of the ceiling panel and/or the edge of the absorber strip.

8. The multifunctional ceiling structure according to claim 1, wherein the ceiling panel has an increased fire resistance value.

9. The multifunctional ceiling structure according to claim 1, wherein the ceiling panel has a two-layer design, and wherein an upwardly directed layer of the ceiling panel extends to the building wall, and downwardly directed layers leave open the strip-shaped free space in which the absorber strip runs.

10. The multifunctional ceiling structure according to claim 1, wherein the absorber strip is detachably mounted.
